(19) United States
(12) Patent Application Publication
(10) Pub. No.: US 2011/0010178 A1
(43) Pub. Date: Jan. 13, 2011

(54) SYSTEM AND METHOD FOR TRANSFORMING VERNACULAR PRONUNCIATION

(75) Inventors: Hyunjung LEE, Seoul (KR); Taeil Kim, Seoul (KR); Hee-Cheol Seo, Seoul (KR); Ji Hye Lee, Seongnam-si (KR)

Correspondence Address: H.C. PARK & ASSOCIATES, PLC, 8500 LEESBURG PIKE, SUITE 7500, VIENNA, VA, 22182, US

(73) Assignee: NHN Corporation, Seongnam-si (KR)

(21) Appl. No.: 12/831,607

(22) Filed: Jul. 7, 2010

(30) Foreign Application Priority Data
Jul. 8, 2009 (KR) 10-2009-0062143

(51) Int. Cl. G10L 13/08

(52) U.S. Cl. 704/260; 704/E13.011

(57) ABSTRACT

Provided is a system and method for transforming vernacular pronunciation with respect to Hanja using a statistical method. In a system for transforming vernacular pronunciation, a vernacular pronunciation extracting unit extracts a vernacular pronunciation with respect to a Hanja character string, a statistical data determining unit determines a statistical data with respect to the Hanja character string by using statistical data of features related to a Hanja-vernacular pronunciation transformation, and a vernacular pronunciation transforming unit transforms the Hanja character string into a vernacular pronunciation using the extracted vernacular pronunciation and the determined statistical data.

### CROSS-REFERENCE TO RELATED APPLICATION

This application claims priority from and the benefit of Korean Patent Application No. 10-2009-0062143, filed on Jul. 8, 2009, which is hereby incorporated by reference for all purposes as if fully set forth herein.

### BACKGROUND

1. Field

Exemplary embodiments of the present invention relate to a system and method for transforming vernacular pronunciation with respect to Hanja using a statistical method.

2. Discussion of the Background

Hanja (Chinese characters) is used in various documents in Asian countries. In addition, Hanja is used in countries, such as the USA, that do not belong to the Hanja cultural is area. Particularly, text documents including Hanja are frequently used in programs using computers. However, some cases occur in which, for some users unfamiliar with Hanja, Hanja is transformed into a vernacular pronunciation in a word-processor program.

For example, in Korea, newspapers, legal documents, and the like in the past were frequently only written in Hanja. However, when Koreans search old newspapers or legal documents, they frequently search for Hanja by inputting the Hangul (Korean characters) pronunciation of the Hanja, as opposed to inputting the Hanja itself. As an example, [symbol] is searched for by inputting [symbol] as a query.

In Japan, Hanja appears more frequently in documents as compared to Korea. However, the Japanese frequently search for Hanja by inputting Yomigana in place of the Hanja. As an example, [symbol] is searched for by inputting [symbol] as a query.

In China, Hanja appears more frequently in documents as compared with other Asian countries. Therefore, the Chinese frequently search for Hanja by inputting the Hanja itself as a query. However, some Chinese search for Hanja by inputting Pinyin in a query. As an example, [symbol] is searched for by inputting ‘kekoukele’ in a query.

In English-speaking countries, such as the USA, Hanja may be used in documents. However, a document can be easily searched for by transforming the Hanja used in the corresponding document into English and inputting the English as queries.

A related method for transforming the Hanja into vernacular pronunciation is performed using a conversion table. Vernacular corresponding to specific Hanja characters are stored in the conversion table. Then, if a Hanja character is inputted by a user, a vernacular corresponding to the Hanja character is presented.

Particularly, users may write documents or input search queries and not recognize is that heteronymous Hanja characters exist and that code values individually exist for each of the heteronymous Hanja character. The heteronymous Hanja character refers to a Hanja character with two or more pronunciations, for example, a Hanja character such as [symbol] with Hangul pronunciations of [symbol] In Extended Unix Code—Korean (EUC-KR) or UNICODE, code values are individually determined for each of the heteronymous Hanja characters. Specifically, in UNICODE, four different code values, i.e., [symbol] 0xF914), [symbol] 0xF95C), [symbol] 0x6A02), and [symbol] 0xF9BF), are provided for the Hanja character

[symbol]

Accordingly, when the number of vernacular pronunciations capable of being transformed with respect to a Hanja character is at least one, the number of finally transformed vernacular pronunciations is also at least one. Therefore, it is necessary to reflect the user's original intention and derive the vernacular pronunciation suitable for the context and vernacular orthography.

Since multiple Hanja characters, each having various code values with respect to documents or queries, exist due to the heteronymous Hanja characters, there may occur a case in which all the documents or queries for a heteronymous Hanja character are not found. For example, if four documents are written respectively with [symbol] =0xF95C), [symbol] =0xF914), [symbol] =0x6A02) and [symbol] =0xF9BF), and, if a user searches documents by inputting [symbol] corresponding to 0xF95C, only one of the four documents may be found.

In Korea, if a Hanja character is transformed into a Hangul pronunciation without considering the Hangul orthography, such as the context and acrophony, an unintended result may be retrieved. For example, there may occur a case in which Hanja characters, such as [symbol] , are transformed into [symbol] rather than [symbol] Since each country has a unique orthography, transformation of the Hanja into vernacular pronunciation in consideration of the orthography may be desired. Accordingly, more accurate transformation of the Hanja into vernacular pronunciation may be desired.

### SUMMARY

Exemplary embodiments of the present invention provide a method and system in which a Hanja character string is transformed into a vernacular pronunciation using statistical data of features related to the Hanja-vernacular pronunciation transformation, thereby enhancing the accuracy of the finally derived vernacular pronunciation.

Exemplary embodiments of the present invention also provide a system and a method for transformation of a heteronymous Hanja character into a vernacular pronunciation suitable for the context and vernacular orthography by using statistical data.

Exemplary embodiments of the present invention also provide a system and a method for transformation of an accurate vernacular pronunciation even if a Hanja character string with an inaccurate code is inputted through a Hanja code normalization.

Exemplary embodiments of the present invention also provide a system and a method for enhancement of reliability of a vernacular pronunciation transformed with respect to a Hanja character string by accurately reflecting exceptional grammar, such as acrophony of Hangul, using statistical data.

Additional features of the invention will be set forth in the description which follows, and in part will be apparent from the description, or may be learned by practice of the invention.

An exemplary embodiment of the present invention discloses a system for transforming vernacular pronunciation, the system including a vernacular pronunciation extracting unit to extract a vernacular pronunciation with respect to a Hanja character string, a statistical data determining unit to determine statistical data with respect to the Hanja character string by using statistical data of features related to a Hanja-vernacular pronunciation transformation, and a vernacular pronunciation transforming unit to transform the Hanja character string into a vernacular pronunciation using the extracted vernacular pronunciation and the determined statistical data.

An exemplary embodiment of the present invention discloses a method for transforming vernacular pronunciation, the method including extracting a vernacular pronunciation with respect to a Hanja character string; determining statistical data with respect to the Hanja character string by using statistical data of features related to a Hanja-vernacular pronunciation transformation; and transforming the Hanja character string into a vernacular pronunciation using the extracted vernacular pronunciation and the determined statistical data.

An exemplary embodiment of the present invention discloses a method for transforming vernacular pronunciation, the method including extracting a vernacular pronunciation with respect to a character string; determining statistical data with respect to the character string by using statistical data of features related to a language-vernacular pronunciation transformation; and transforming the character string into a vernacular pronunciation using the extracted vernacular pronunciation and the determined statistical data.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a process of transforming a vernacular pronunciation with respect to a Hanja character string through a system for transforming vernacular pronunciation according to an exemplary embodiment of the present invention.

FIG. 2 is a block diagram illustrating a system for transforming vernacular pronunciation according to an exemplary embodiment of the present invention.

FIG. 3 is a diagram illustrating a process of normalizing a Hanja character string according to an exemplary embodiment of the present invention.

FIG. 4 is a diagram illustrating an example of a Hanja-vernacular pronunciation table according to an exemplary embodiment of the present invention.

FIG. 5 is a diagram illustrating a method for transforming a vernacular pronunciation with respect to a Hanja character string according to an exemplary embodiment of the present invention.

FIG. 6 is a flowchart illustrating a method for transforming vernacular pronunciation according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as is limited to the exemplary embodiments set forth herein. Rather, these exemplary embodiments are provided so that this disclosure is thorough, and will convey the scope of the invention to those skilled in the art. In the drawings, the size and relative sizes of layers and regions may be exaggerated for clarity. Like reference numerals in the drawings denote like elements.

A method for transforming vernacular pronunciation may be performed by a system for transforming vernacular pronunciation.

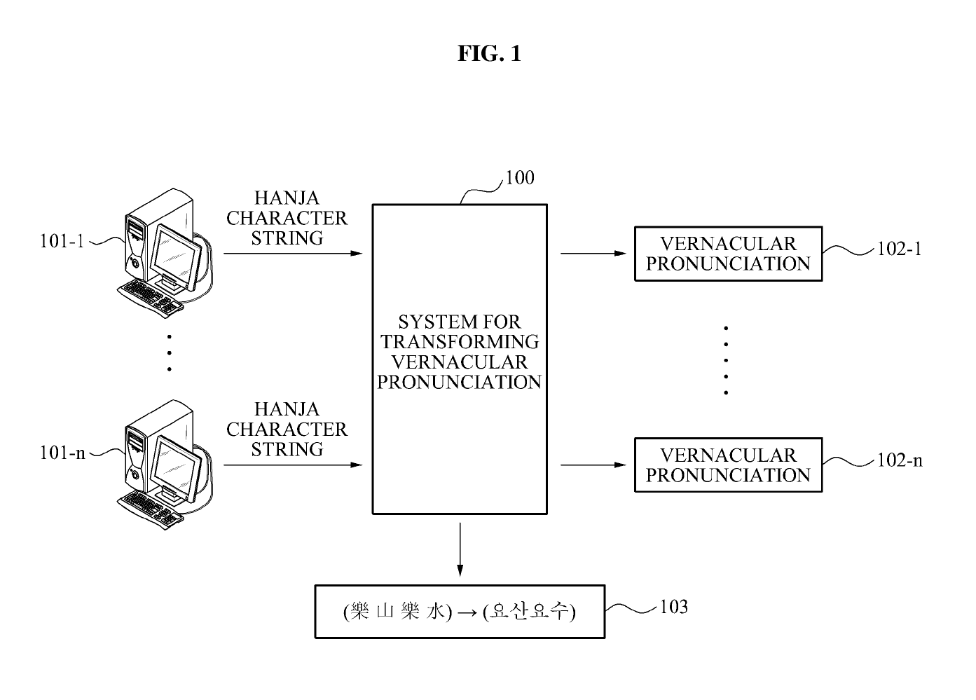

FIG. 1 is a diagram illustrating a process of transforming a vernacular pronunciation with respect to a Hanja character string through a system 100 for transforming vernacular pronunciation according to an exemplary embodiment of the present invention. Although described herein with respect to Hanja, aspects of the present invention are not limited thereto such that features described herein may be applied to other languages and characters.

If a user inputs via at least one of terminals 101-1 to 101-n a Hanja character string including at least one Hanja character, the system 100 can transform the Hanja character string into a vernacular pronunciation 102-1 to 102-n. The vernacular may be differently determined based on the language written in a document provided by or to the system 100. For example, if the system 100 provides or is provided with a Hangul document, the vernacular may be determined as Hangul.

In this case, the Hanja character string includes at least one Hanja character. Hanja characters included in a text document may be transformed into vernacular pronunciations in a program (a program for a personal computer (PC), a program for a server, a program for the Internet, and the like) using a computer. For example, if a user inputs [symbol] as a Hanja character string, the system 100 may transform the Hanja character string into [symbol] that is a vernacular pronunciation 102-1 to 102-n. If the user inputs a Hanja character string as a search query, the amount of search results is relatively small when the Hanja character string inputted to a search engine is searched for as is. Hence, the system 100 transforms the Hanja character string into the vernacular pronunciation 102-1 to 102-n so that the search engine can derive more appropriate search results.

If a Hanja character string is included in a text document, the system 100 transcribes a vernacular pronunciation 102-1 to 102-n with respect to the Hanja character string at the point at which the corresponding Hanja character string is positioned so that the user can more conveniently read the text document. As can be seen in a transformation example 103 of FIG. 1, if a Hanja character string, i.e., [symbol] is included in the text document, the system 100 may transform the Hanja character string into a Hangul pronunciation, i.e.,

[symbol]

The system 100 uses data obtained by statistically analyzing the data transformed into a vernacular pronunciation with respect to a given Hanja character string, thereby providing a more accurate vernacular pronunciation. Also, the system 100 provides vernacular pronunciation suitable for the context and vernacular orthography, thereby providing a more accurate vernacular pronunciation.

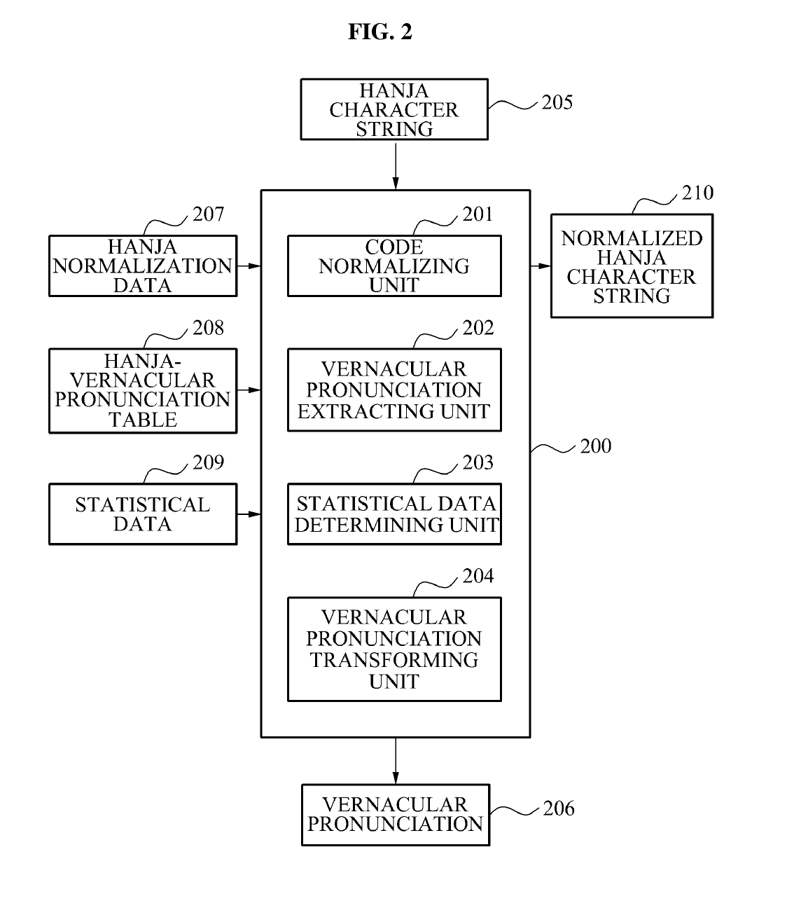

FIG. 2 is a block diagram illustrating a system for transforming vernacular pronunciation according to an exemplary embodiment of the present invention. Referring to FIG. 2, the system 200 may include a code normalizing unit 201, a vernacular pronunciation extracting unit 202, a statistical data determining unit 203, and a vernacular pronunciation transforming unit 204.

The code normalizing unit 201 normalizes the code of a Hanja character string 205 including a heteronymous Hanja character having a same form and different codes. As an example, the code normalizing unit 201 may normalize the code of the Hanja character string 205 by transforming the heteronymous Hanja character as a representative Hanja character. In this case, the code normalizing unit 201 may normalize the code of the Hanja character string 205 using Hanja normalization data 207.

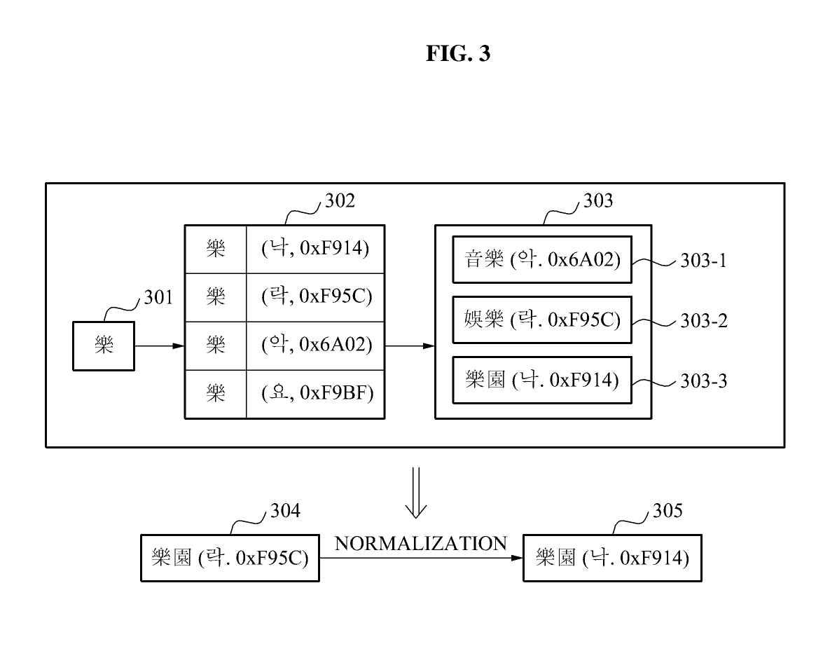

As a result, a normalized Hanja character string 210 normalized by the code normalizing unit 201 can be derived. However, if the Hanja character string 205 includes no heteronymous Hanja character, the code normalizing unit 201 may not operate. The operation of the code normalizing unit 201 will be described in detail with reference to FIG. 3.

The vernacular pronunciation extracting unit 202 extracts a vernacular pronunciation with respect to a Hanja character string using a Hanja-vernacular pronunciation table 208. The Hanja-vernacular pronunciation table 208 may include pairs or multiples of vernacular pronunciations for respective Hanja characters. That is, according to the Hanja-vernacular pronunciation table 208, a vernacular pronunciation may correspond to each of the Hanja characters.

However, if one or more pronunciations correspond to the same Hanja character, the vernacular pronunciation may be transformed to be suitable for the context and vernacular orthography. Accordingly, the system 200 can enhance the accuracy of the vernacular pronunciation transformed using statistical data transformed into the vernacular from the Hanja.

The statistical data determining unit 203 determines statistical data with respect to a Hanja character string using the statistical data of features related to the Hanja-vernacular pronunciation transformation 208.

As an example, the statistical data determining unit 203 may determine statistical data with respect to the Hanja character string 205 using statistical data 209 that is extracted from data in which the Hanja and vernacular are represented together and corresponds to meaningful features with respect to the Hanja-vernacular transformation. The statistical data determining unit 203 may determine the syllable probability and transition probability with respect to syllables of a vernacular pronunciation 206 related to the Hanja character string 205.

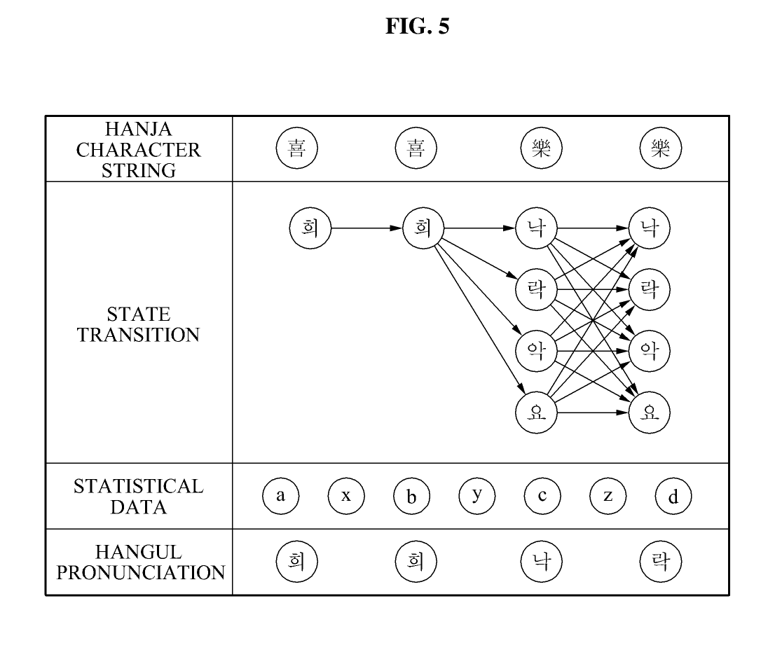

That is, the statistical data determining unit 203 may more accurately determine the vernacular differently pronounced with respect to the same Hanja character depending on conditions by using various statistical data transformed into the vernacular with respect to the Hanja. The process of using statistical data will be further described with reference to FIG. 5.

The vernacular pronunciation transforming unit 204 transforms the Hanja character string 205 into an optimal vernacular pronunciation 206 using the extracted vernacular pronunciation and the determined statistical data. As an example, the vernacular pronunciation transforming unit 204 may determine a vernacular pronunciation 206 having a maximum probability of the vernacular pronunciation to be transformed with respect to the Hanja character string 205.

In this case, the vernacular pronunciation transforming unit 204 may transform the Hanja character string 205 into the vernacular pronunciation 206 based on a Hidden Markov Model, but aspects are not limited thereto such that other models may be used. The vernacular pronunciation transforming unit 204 may transform the Hanja character string 205 into the vernacular pronunciation 206 having an optimal path with respect to the Hanja character string 205 by applying a Viterbi algorithm to Hanja character strings that are repeatedly processed.

FIG. 3 is a diagram illustrating a process of normalizing a Hanja character string according to an exemplary embodiment of the present invention.

Although a Hanja character string may not be transformed into a vernacular pronunciation, words each having various code values exist in documents or queries due to heteronymous Hanja characters. Hence, a search may not be performed. Therefore, the code of a Hanja character string including a heteronymous Hanja character with the same form and different codes may be normalized.

For example, a Hanja list of four different codes with the same form and different Hangul pronunciations may be derived from [symbol] 301. If the [symbol] 301 is inputted as [symbol] 0xF9BF) 302, a search result 303 including [symbol] 0x6A02) 303-1, [symbol] 0xF95C) 303-2 and [symbol] 0xF914) 303-3 may not be retrieved. Therefore, the system for transforming vernacular pronunciation may perform normalization with respect to a Hanja character string including a heteronymous Hanja character.

Vernacular pronunciations with respect to a heteronymous Hanja character may be differently defined for different countries, regions, and/or populations. For example, the [symbol] may be pronounced as [symbol] or [symbol] in Hangul. However, [symbol] the may be pronounced as [symbol] or [symbol] in Japanese. In addition, [symbol] may be pronounced as ‘yue’ or ‘le’ in Chinese.

As an example, the system may normalize the code of a Hanja character string by transforming a heteronymous Hanja character into a representative Hanja character. In this case, the system may normalize the code of a Hanja character string using a normalization data built through a Hanja dictionary. That is, although a user inputs [symbol] 0xF95C) 304, the system may normalize the [symbol] that is a heteronymous Hanja character and transformed as a representative Hanja character. Then, the system may derive a normalized Hanja character string 305.

The system may solve the problem of data scarcity in a statistical model through the normalization process of a Hanja character string. Also, the system may transform a vernacular pronunciation with a Hanja character used with a code unsuitable for the context and vernacular orthography.

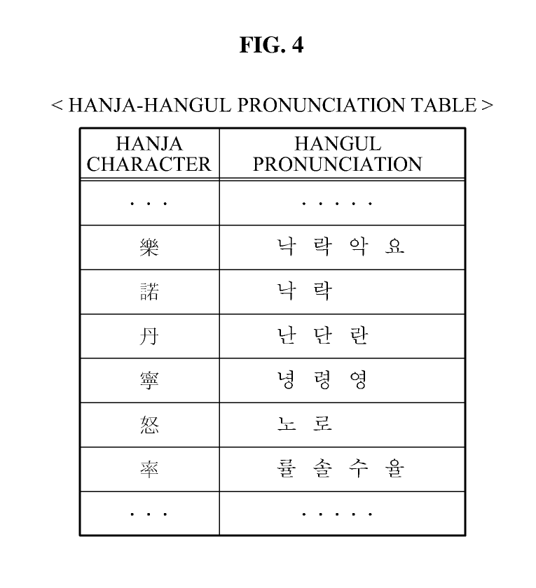

FIG. 4 is a diagram illustrating an example of a Hanja-vernacular pronunciation table according to an exemplary embodiment of the present invention. Particularly, FIG. 4 illustrates an example of a Hanja-Hangul pronunciation table. The description of FIG. 4 may be analogically applied for other pronunciations, languages, and/or characters.

The Hanja-Hangul pronunciation table may include pairs or multiples of vernacular pronunciations for respective Hanja characters. Particularly, the Hanja-Hangul pronunciation table may be applied to a case in which one Hanja character has a plurality of Hangul pronunciations. As can be seen in FIG. 4, [symbol] the may be pronounced as [symbol] and [symbol] in Hangul.

For example, if a Hanja character [symbol] is included in a Hanja character string inputted by a user, the system for transforming vernacular pronunciation may extract Hangul pronunciations [symbol] and [symbol] with respect to the Hanja character [symbol] using the Hanja-Hangul pronunciation table.

A Hanja-Japanese pronunciation table may include Japanese pronunciations [symbol] and [symbol] with respect to the Hanja character [symbol] In addition, a Hanja-Chinese pronunciation table may include Chinese pronunciations (Pinyin) ‘yue’ and ‘le’ with respect to the Hanja character

[symbol]

FIG. 5 is a diagram illustrating a method for transforming a vernacular pronunciation with respect to a Hanja character string according to an exemplary embodiment of the present invention. Referring to FIG. 5, it is assumed that a Hanja character string [symbol] is inputted. The system for transforming vernacular pronunciation may transform vernacular pronunciations with respect to characters constituting the Hanja character string by using a Hanja-vernacular pronunciation table. As an example, [symbol] may be transformed into [symbol] and [symbol] may be transformed into [symbol] and

[symbol]

The system may determine statistical data with respect to a Hanja character string using the statistical data of features related to the Hanja-vernacular pronunciation transformation. As an example, the system may determine statistical data with respect to the Hanja character string using statistical data that is extracted from data in which the Hanja and vernacular are represented together and corresponds to features with respect to the Hanja-vernacular transformation.

The features may be varied depending on grammar and orthography. The features with respect to the Hanja-Hangul transformation may include the following probabilities:
Probability that a current Hangul pronunciation appears together with a current Hanja character (e.g., probability that [symbol] is transformed into [symbol]
Probability that a current Hangul pronunciation appears together with a previous Hangul pronunciation (e.g., probability that [symbol] appears before [symbol]
Probability that a current Hanja character appears together with a previous Hangul pronunciation (e.g., probability that [symbol] appears before [symbol]
Probability that a current Hangul pronunciation appears together with a Hangul pronunciation before the previous Hangul pronunciation (e.g., probability that [symbol] appears before another [symbol] with a Hangul pronunciation interposed therebetween)
Probability that a current Hanja character appears together with a Hangul pronunciation before the previous Hangul pronunciation (e.g., probability that [symbol] appears before [symbol] with a Hangul pronunciation interposed therebetween)
Probability that if a current Hanja character is [symbol] and the following Hanja pronunciation is starting with [symbol] or [symbol] the [symbol] is pronounced as [symbol]
Probability that if a current Hanja character is [symbol] and its current position is placed at the head of a word, the [symbol] is pronounced as [symbol] (acrophony)
Probability that when a current Hanja character is [symbol] and its current position is placed at the end of a word, the [symbol] is pronounced as

[symbol]

The probability for the aforementioned features may be statistically determined using data from blogs, documents, web pages, and the like, in which the vernacular and Hanja are represented together. Particularly, various acrophonies exist in Hangul pronunciations, and many exceptions for the acrophonies also exist. Hence, it is possible to enhance the accuracy of Hangul pronunciations transformed using a statistical data that is extracted from data in which the Hanja and vernacular are represented together and corresponds to features with respect to the Hanja-vernacular transformation. Since unique orthographies exist in other countries, regions, and populations, like the Korean acrophony, statistical data suitable for conditions of each country, region, or population may be derived using features that reflect the unique orthographies.

The below details may be used as features applied to the statistical data. As an example, the acrophonies for Hangul pronunciations and their exceptions are as follows:
If a Hangul pronunciation having an initial sound of [symbol] appears at the beginning of a word, the [symbol] is pronounced as [symbol] (e.g., [symbol] [symbol] [symbol]
If a Hangul pronunciation having an initial sound of [symbol] appears at the beginning of a word, the [symbol] is pronounced as [symbol] (e.g., [symbol] [symbol] [symbol] . . . )
If a Hangul pronunciation having an initial sound of [symbol] appears at the beginning of a word, the [symbol] is pronounced as [symbol] (e.g., [symbol] [symbol] [symbol] . . . )
Acrophony exists in derivative words and compound words (the boundary between words exists in a word phrase) (e.g., [symbol] [symbol] [symbol] . . . )
Exceptions of the acrophony (e.g., [symbol] [symbol] ), [symbol] [symbol] . . . )

The system may determine statistical data with respect to a Hanja character string. As an example, the system may calculate the syllable probability and transition probability with respect to syllables of a vernacular pronunciation related to a Hanja character string, thereby determining the statistical data with respect to the Hanja character string. Referring to FIG. 5, [symbol] and [symbol] and [symbol] and [symbol] transformed into Hangul pronunciations with respect to a Hanja character string [symbol] may be configured as respective states.

In this case, the probability that a Hanja character corresponding to any one syllable in the Hanja character string is transformed into a vernacular pronunciation may be defined as a syllable probability. For example, the probability that a Hanja character [symbol] is transformed into a Hangul pronunciation [symbol] may be defined as a syllable probability with respect to the Hanja character [symbol] In addition, the probability that a Hanja character [symbol] is transformed into a Hangul pronunciation [symbol] may be defined as a syllable probability with respect to the Hanja character [symbol] In FIG. 5, the syllable probabilities that are statistical data determined with respect to the Hanja character string may be determined as “a,” “b,” “c” and “d,” respectively.

The probability the vernacular pronunciation of a next Hanja character appears with respect to the vernacular pronunciation of a specific Hanja character in the transition of a state may be defined as a transition probability. For example, the probability that the Hangul pronunciation of a Hanja character [symbol] and the Hangul pronunciation of another Hanja character [symbol] that appears after the former Hanja character [symbol] may be defined as the transition probability of the another Hanja character [symbol] Also, the probability that the Hangul pronunciation of a Hanja character [symbol] and the Hangul pronunciation of a Hanja character [symbol] that appears after the other Hanja character [symbol] may be defined as the transition probability of the Hanja character [symbol] that appears after the another Hanja character [symbol] In FIG. 5, the transition probabilities that are statistical data determined with respect to the Hanja character string may be determined as “x,” “y” and “z,” respectively.

The system may transform the Hanja character string into the optimal vernacular pronunciation using the extracted vernacular pronunciation and the determined statistical data. As an example, the system may determine a vernacular pronunciation with the maximum probability that the Hanja character string is transformed into a desired vernacular pronunciation using the syllable probability and transition probability, which are statistical data. In this case, the system may transform a Hanja character string into a vernacular pronunciation using a Hidden Markov Model.

For Korean, the Hanja character string may be transformed into a Hangul pronunciation. For Japanese, the Hanja character string may be transformed into a Yomigana [symbol] or [symbol] pronunciation. For Chinese, the Hanja character string may be transformed into a Pinyin pronunciation. In this case, the Pinyin may be obtained by transcribing Chinese pronunciations into Roman characters.

In the case of English-speaking countries, regions, and/or populations such as the USA and the UK, the Hanja character string may be transformed into Romaji (transcription of Japanese into Roman characters) or Pinyin (transcription of Chinese into Roman characters). For example, ‘I like [symbol] may be transformed into ‘I like sushi ’ as the transcription in Roman characters. As another example, [symbol] visited’ may be transformed into ‘Liu Bei visited’ as the transcription in Pinyin.

As an example, the system may transform a vernacular pronunciation with respect to a Hanja character string using a Hidden Markov Model according to the following Expression 1.

$$\begin{matrix}\begin{matrix}Γ ( C ) = {arg max}_{K} P 〈 K \vert C 〉 \\ = {arg max}_{K} P ( K , C )\end{matrix} & [ Expression 1 ] \\ \begin{matrix}P ( K , C ) = P ( {k}_{1 , n} , {c}_{1 , n} ) \\ = P ( {c}_{1} ) \cdot P 〈 {k}_{1} \vert {c}_{1} 〉 \cdot P 〈 {c}_{2} \vert {c}_{1} , {k}_{1} 〉 \cdot P 〈 {k}_{2} \vert {c}_{1 , 2} , {k}_{1} 〉 \cdot \\ P 〈 {c}_{3} \vert {c}_{1 , 2} , {k}_{1 , 2} 〉 \cdot P 〈 {k}_{3} \vert {c}_{1 , 3} , {k}_{1 , 2} 〉 Λ \cdot \\ P 〈 {c}_{n} \vert {c}_{1 , n - 1} , {k}_{1 , n - 1} 〉 \cdot P 〈 {k}_{n} \vert {c}_{1 , n} , {k}_{1 , n - 1} 〉 \\ \approx {\prod }_{i = 1}^{n} P 〈 {c}_{i} \vert {c}_{i - M , i - 1} , {k}_{i - J , i - 1} 〉 \cdot P 〈 {k}_{i} \vert {c}_{i - L , i} , {k}_{i - I , i - 1} 〉\end{matrix} & \end{matrix}$$

In this case, C denotes a Hanja character string, and K denotes a vernacular pronunciation. Also,

$${\prod }_{i = 1}^{n} P 〈 {c}_{i} \vert {c}_{i - M , i - 1} , {k}_{i - J , i - 1} 〉$$

is a syllable probability, and P [symbol] kᵢ|c_{i-L,i},k_{i-I,i-1} [symbol] is a transition probability.

Then, the vernacular pronunciation finally transformed with respect to the Hanja character string may be determined according to the following Expression 2.

$${arg max}_{{k}_{1 , n}} {\prod }_{i = 1}^{n} P 〈 {c}_{i} \vert {c}_{i - 2 , i - 1} , {k}_{i - 2 , i - 1} 〉 \cdot P 〈 {k}_{i} \vert {c}_{i - 1 , i} , {k}_{i - 2 , i - 1} 〉 \qquad [ Expression 2 ]$$

That is, the system may determine a vernacular pronunciation with the maximum combination of the syllable probability and transition probability with respect to a given Hanja character string. In this case, the system may transform the Hanja character string into the vernacular pronunciation having the optimal path with respect to the Hanja character string by applying the Viterbi algorithm to Hanja character strings that are repeatedly processed.

Through the above described processes, the vernacular pronunciation with respect to the Hanja character string [symbol] can be determined as [symbol] as shown in FIG. 5.

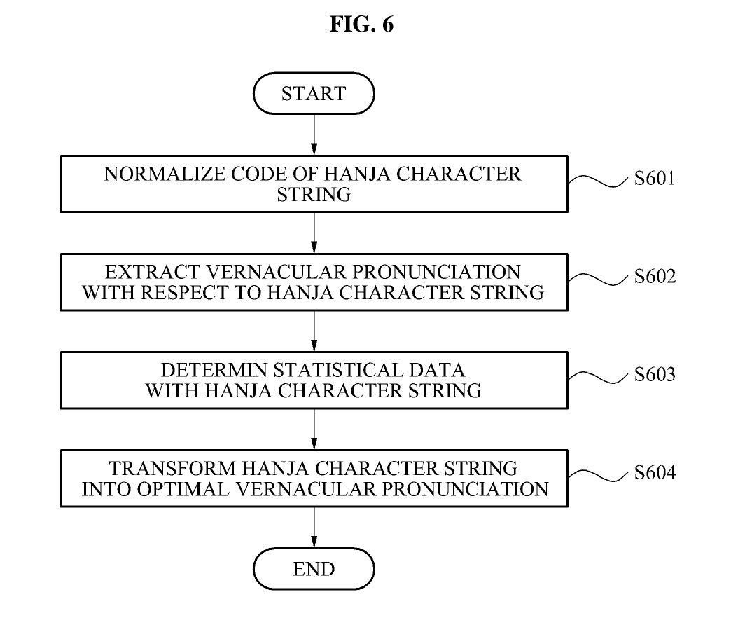

FIG. 6 is a flowchart illustrating a method for transforming vernacular pronunciation according to an exemplary embodiment of the present invention. The system for transforming vernacular pronunciation may normalize the code of a Hanja character string in operation S601. As an example, the system may normalize the code of a Hanja character string including a heteronymous Hanja character with a same form and different codes. In this case, the system may normalize the code of the Hanja character string by transforming the heteronymous Hanja character to a representative Hanja character using normalization data. Here, the normalization data may be built from a dictionary.

The system may extract a vernacular pronunciation with respect to the Hanja character string in operation S602. As an example, the system may extract the vernacular pronunciation with respect to the Hanja character string by using a Hanja-vernacular pronunciation table that includes pairs or multiples of vernacular pronunciations for respective Hanja characters. In this case, when the Hanja character string passes through the normalization process, the system can extract the vernacular pronunciation with respect to the normalized Hanja character string.

The system may determine a statistical data with respect to the Hanja character string by using statistical data of features related to the Hanja-vernacular pronunciation transformation in operation S603. As an example, the system may determine statistical data with respect to the Hanja character string using statistical data that is extracted from data in which the Hanja and vernacular are represented together and corresponds to features with respect to the Hanja-vernacular transformation. In this case, the system may determine the syllable probability and transition probability with respect to syllables of the vernacular pronunciation related to the Hanja character string.

The system may transform the Hanja character string into a vernacular pronunciation using the extracted vernacular pronunciation and the determined statistical data in operation S604. As an example, the system may determine a vernacular pronunciation with a maximum probability of the vernacular pronunciation to be transformed with respect to the Hanja character string.

In this case, the system may transform the Hanja character string into the vernacular pronunciation based on a Hidden Markov Model. Particularly, the system may transform the Hanja character string into the vernacular pronunciation having an optimal path with respect to the Hanja character string by applying a Viterbi algorithm to Hanja character strings that are repeatedly processed.

Details that are not described in FIG. 6 may be understood by referring to the descriptions of FIGS. 1 to 5.

The method according to an exemplary embodiment of the present invention may include non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for transforming vernacular pronunciation, the system comprising:
a vernacular pronunciation extracting unit to extract a vernacular pronunciation with respect to a Hanja character string;
a statistical data determining unit to determine statistical data with respect to the Hanja character string by using statistical data of features related to a Hanja-vernacular pronunciation transformation; and
a vernacular pronunciation transforming unit to transform the Hanja character string into a vernacular pronunciation using the extracted vernacular pronunciation and the determined statistical data.

2. The system of claim 1, wherein the vernacular pronunciation extracting unit extracts the vernacular pronunciation using a Hanja-vernacular pronunciation table that includes vernacular pronunciations for respective Hanja characters.

3. The system of claim 1, further comprising:
a code normalizing unit to normalize a code of the Hanja character string including a heteronymous Hanja character with a same form and different codes,
wherein the vernacular pronunciation extracting unit extracts the vernacular pronunciation with respect to the Hanja character string of which the code is normalized.

4. The system of claim 3, wherein the code normalizing unit normalizes the code of the Hanja character string by transforming the heteronymous Hanja character into a representative Hanja character.

5. The system of claim 1, wherein the statistical data determining unit determines the statistical data with respect to the Hanja character string by using statistical data extracted from data in which the Hanja and the vernacular are represented together and corresponds to features with respect to the Hanja-vernacular transformation.

6. The system of claim 1, wherein the statistical data determining unit determines a syllable probability and a transition probability with respect to a syllable of the vernacular pronunciation related to the Hanja character string.

7. The system of claim 1, wherein the vernacular pronunciation transforming unit determines the vernacular pronunciation having the maximum probability of the vernacular pronunciation to be transformed with respect to the Hanja character string.

8. The system of claim 7, wherein the vernacular pronunciation transforming unit transforms the Hanja character string into the vernacular pronunciation based on a Hidden Markov Model.

9. The system of claim 8, wherein the vernacular pronunciation transforming unit transforms the Hanja character string into the vernacular pronunciation having an optimal path with respect to the Hanja character string by applying a Viterbi algorithm to Hanja character strings that are repeatedly processed.

10. A method for transforming vernacular pronunciation, the method comprising:
extracting a vernacular pronunciation with respect to a Hanja character string;
determining statistical data with respect to the Hanja character string by using statistical data of features related to a Hanja-vernacular pronunciation transformation; and
transforming the Hanja character string into a vernacular pronunciation using the extracted vernacular pronunciation and the determined statistical data.

11. The method of claim 10, wherein the extracting the vernacular pronunciation comprises:
extracting the vernacular pronunciation using a Hanja-vernacular pronunciation table that includes vernacular pronunciations for respective Hanja characters.

12. The method of claim 11, further comprising normalizing a code of the Hanja character string including a heteronymous Hanja character with a same form and different codes,
wherein the extracting the vernacular pronunciation with respect to the Hanja character string comprises extracting the vernacular pronunciation with respect to the Hanja character string of which the code is normalized.

13. The method of claim 12, wherein the normalizing the code of the Hanja character string comprises:
normalizing the code of the Hanja character string by transforming the heteronymous Hanja character into a representative Hanja character.

14. The method of claim 10, wherein the determining the statistical data with respect to Hanja character string comprises:
determining the statistical data with respect to the Hanja character string by using statistical data extracted from data in which the Hanja and the vernacular are represented together and corresponds to features with respect to the Hanja-vernacular transformation.

15. The method of claim 10, wherein the determining the statistical data with respect to Hanja character string comprises:
determining a syllable probability and a transition probability with respect to a syllable of the vernacular pronunciation related to the Hanja character string.

16. The method of claim 10, wherein the transforming the Hanja character string into the vernacular pronunciation comprises:
determining a vernacular pronunciation having the maximum probability of the vernacular pronunciation to be transformed with respect to the Hanja character string.

17. The method of claim 16, wherein the transforming the Hanja character string into the optimal vernacular pronunciation comprises:
transforming the Hanja character string into the vernacular pronunciation based on a Hidden Markov Model.

18. The method of claim 17, wherein the transforming the Hanja character string into the optimal vernacular pronunciation comprises:
transforming the Hanja character string into the vernacular pronunciation having an optimal path with respect to the Hanja character string by applying a Viterbi algorithm to Hanja character strings that are repeatedly processed.

19. A non-transitory computer-readable medium in which a program for performing the method of claim 10 is recorded.

20. A method for transforming vernacular pronunciation, the method comprising:
extracting a vernacular pronunciation with respect to a character string;
determining statistical data with respect to the character string by using statistical data of features related to a language-vernacular pronunciation transformation; and
transforming the character string into a vernacular pronunciation using the extracted vernacular pronunciation and the determined statistical data.
